(19) United States
(12) Patent Application Publication
(10) Pub. No.: US 2011/0203668 A1
(43) Pub. Date: Aug. 25, 2011

(54) TRANSMISSION OIL CIRCUIT

(76) Inventors: Bernhard Hofig, Heidenheim (DE); Christoph Wurster, Lonsee (DE); Michael Gerlich, Konigsbronn (DE); Michael Reik, Ulm (DE)

(21) Appl. No.: 12/736,585

(22) PCT Filed: Jul. 22, 2010
(86) PCT No.: PCT/EP2010/004489

§ 371 Date: Dec. 27, 2010

(30) Foreign Application Priority Data
Jul. 28, 2009 (DE) 10 2009 035 082.9

(51) Int. Cl. F15D 1/00

(52) U.S. Cl. 137/1; 137/340

(57) ABSTRACT

The invention concerns a transmission oil circuit
with an oil pump for feeding oil or another fluid from an oil sump or corresponding fluid sump;
with a heat exchanger, the oil flows through, for evacuating the heat from the oil;
with a work pressure valve, against which the oil pump conveys the oil, so as to bring the conveyed oil to a preset work pressure for pressure actuation, applying hydraulic pressure or conveying hydraulic pressure to switching valves and/or other transmission components and/or other units outside the transmission, which are arranged in the flow direction upstream of the work pressure valve in a row with respect thereto or in the flow direction downstream of a supply line, which branches off in the transmission oil circuit upstream of the work pressure valve.

The invention is characterised in that
the heat exchanger can be switched alternately into a first position upstream of
the work pressure valve or into a second position downstream of the work pressure valve as regards the circulation sequence of the oil coming out of the oil pump, or
the heat exchanger can be switched alternately into a first position upstream of the switching valves or into a second position downstream of the switching valves as regards the circulation sequence of the oil coming out of the oil pump, other transmission components and/or other units in an arrangement inside or downstream of the branched off supply line, upstream or downstream of the branch-off point.

The present invention concerns a transmission oil circuit and a method for controlling the oil flow in such a circuit, having the characteristics detailed in the preamble of the claim 1 and according to the preamble of claim 6.

Transmissions, in particular vehicle transmissions, present a transmission on the one hand for lubricating transmission parts and on the other hand for pressure actuation of or applying hydraulic pressure on transmission components. The oil of the transmission oil circuit can also can be resorted to as a working fluid of a hydrodynamic machine, which is provided in the transmission, on the transmission or outside the transmission and is designed for instance as a hydrodynamic converter, a hydrodynamic coupling or a hydrodynamic retarder. Transmission components are in particular couplings, in particular lamella packet couplings, claw couplings or other coupling devices, in order to adjust different revolution speeds and torques to form different gear ratios in the transmission between a transmission input shaft and a transmission output shaft.

Oil is normally conveyed out of an oil sump in such a transmission oil circuit to make said oil available for the tasks aforementioned. As a rule, the oil pump, which for instance may be arranged as a toothed gear, operates against a work pressure valve, also called main pressure valve, which ensures that a sufficient oil pressure is available for the different components. This oil pressure is designated as line pressure or work pressure, with one or several circuits or channels, which transport the work pressure, also as a work pressure level.

Understandably so, the output power of the oil pump should be high enough, in order to convey the oil to the requested work pressure or dynamic pressure upstream of the work pressure valve. Additionally, components filled with said oil are provided in the oil circuit upstream and downstream of the pump, however upstream of the work pressure valve, which cause more or less pressure loss, which additionally must be compensated for through the oil pump. The oil pump should hence provide a comparatively greater power, than required on its own through the accumulation of the oil stream with the work pressure valve.

In order to protect the oil flowing in the oil circuit against inadmissible superheating due to any heat input caused by different components situated in the oil circuit, at least one heat exchanger is provided with which the heat input into the oil circuit is evacuated from the oil, for instance to the surrounding atmosphere or to a cooling circuit connected for the transmission of heat with the heat exchanger. Such a heat exchanger has been positioned until now in the flow direction, seen from the oil pump, upstream of the work pressure level, to guarantee reliably that the switching valves arranged in the flow direction parallel to the work pressure valve in the work pressure level and possibly additional components are protected against exposure to excessively hot oil. Consequently, the switching valves usually exhibit namely electrical components which are heat sensitive.

Due to the positioning of the heat exchanger in the flow direction of the oil downstream of the oil pump and upstream of the work pressure valve, the pressure loss inevitably occurring in the heat exchanger involves that the oil pump must feed the conveyed oil at higher pressure as should be accumulated by the work pressure valve. The power absorption of the oil pump is accordingly comparatively high.

The object of the present invention is then to provide a transmission oil circuit or a method for controlling the oil flow in a transmission oil circuit, wherein the power absorption of the oil pump, considered over the whole operating range, can be comparatively reduced, without running the risk of any inadmissible heating of individual components in the transmission oil circuit.

The object of the invention is satisfied with a transmission oil circuit exhibiting the features of claim 1 and a method according to claim 6. Advantageous and particularly appropriate embodiments of the invention are disclosed in the dependent claims.

The transmission oil circuit according to the invention includes an oil pump for feeding oil from an oil sump as well as a heat exchanger the oil flows through, for evacuating the heat from the oil. As represented, the heat exchanger can be applied on the secondary side (related to the oil circuit) by air i.e. the surrounding air or even a cooling fluid circuit, providing the heat exchanger is suitable for evacuating the heat from the oil of the oil circuit.

The transmission oil circuit moreover includes a work pressure valve against which the oil pump conveys the oil, in particular immediately from the oil sump or also on the suction side the oil returned to the oil pump. A valve variable in its flow cross-section is usually provided as a work pressure valve. Other accumulation systems can also be taken into consideration however, such as a work pressure throttle valve with adjustable flow cross-section or a work pressure throttle valve with constant flow cross-section. The desired work pressure should decisively be made available by means of the work pressure valve in the transmission oil circuit, so that switching valves and/or other transmission components and/or units outside the transmission can be pressurised with said oil or to load with pressurised oil and/or to provide the oil for conveying the pressurised oil. The switching valves, transmission components or units outside the transmission, which should be supplied with said oil on the accumulated pressure level and which could be designated as consumer devices, although they should not consume the oil properly speaking, may be arranged upstream of the work pressure valve and in a row with respect thereto in the transmission oil circuit and/or in a supply line, which branches off upstream of the work pressure valve, in particular immediately upstream thereof. In the latter case, the switching valves respective the transmission components or units outside the transmission are arranged so to say parallel to the work pressure valve. The switching valves, transmission components or units need naturally not be positioned immediately in the supply line, but may be arranged also in the flow direction of the oil downstream of the supply line for the parallel connection mentioned. The work pressure valve can advantageously be controlled or regulated, in order to vary the flow cross-section for the through-flowing oil of the transmission oil circuit and hence to enable more or less strong accumulation, also comprising the complete release of the flow cross-section without accumulation.

And to avoid any pressure loss in the flow direction between the oil pump and the work pressure valve, in specific operating modes wherein comparatively little heat is input into the oil of the transmission oil circuit and where consequently transmission components, in particular switching valves fitted with electronic components should not be exposed (or hardly) to excessively warm oil of the transmission oil circuit, the heat exchanger can be switched alternately before or after the work pressure valve, according to the invention as regards the sequence of oil circulation, starting from the oil pump. So the heat exchanger in a first operating mode can be switched into a first position upstream of the work pressure valve (first position) and the oil fed through the oil pump can be conveyed first through the heat exchanger and then through the work pressure valve, and in a second operating mode the heat exchanger can be switched into a second position downstream of the work pressure valve (second position) and the oil fed through the oil pump can be is conveyed first through the work pressure valve and then through the heat exchanger. There is hence no pressure loss caused by a heat exchanger between the oil pump and the work pressure valve in the second operating mode, respective, if additionally to the switchable heat exchanger one more heat exchanger is provided between the oil pump and the work pressure valve, the pressure loss is reduced by extracting the switchable heat exchanger according to the invention upstream of the work pressure valve.

According to an alternative embodiment of the invention, with which such effect can be obtained, the switchable heat exchanger can be switched alternately between a first position upstream of the switching valves, of the other transmission components and/or other units outside the transmission or, in case of arrangement of these switching valves, transmission components and/or other units in or downstream of a supply line branching off upstream of the work pressure valve, before the branch-off point and a second position downstream of the switching valves, other transmission components and/or other units respective downstream of the branch-off point. In such a case, namely if the switching valve is switched into the first position, the oil can be cooled, before reaching the switching valves, other transmission components and/or other units outside the transmission, which is associated with a pressure loss when said oil flows through the switchable heat exchanger, which must be compensated for by a larger power consumption through the oil pump, in order to make available a sufficiently high work pressure on the branch-off point respective in the region of the switching valves, other transmission components and/or other units. In the second position conversely, the pressure loss takes place in the heat exchanger in the flow direction downstream of the branch-off point respectively the switching valves, other transmission components and/or other units, so that a comparatively lower accumulation can be adjusted by means of the work pressure valve, which is added together with the pressure loss in the heat exchanger to obtain the requested accumulation effect, without the oil pump having to compensate for the pressure loss in the heat exchanger.

If a hydrodynamic retarder is provided, which is driven with said oil of the transmission oil circuit and hence with the oil conveyed through the oil pump acting as the working fluid, which is supplied in the toroidal work space of the retarder in order to transmit a torque hydrodynamically from a rotor to a stator or from a rotor to a counter-rotating rotor, or whose working fluid is conveyed in a separate circuit according to an alternative embodiment, and is however cooled through the transmission oil circuit, comparatively significant heat is always input into the oil of the transmission oil circuit, when the retarder is switched on. The switchable heat exchanger is advantageously switched in the transmission oil circuit always in the flow direction of the oil, starting from the oil pump, before the work pressure valve or according to the alternative embodiment into the first position upstream of the aforementioned switching valves/other transmission components/other units or the branch-off point, when the retarder is switched on, whereas conversely said heat exchanger can be switched in the flow direction downstream of the work pressure valve or in the alternative configuration downstream of the switching valves/other transmission components/other units respective the branch-off point, when the retarder is switched off. It should still be noted in the latter case, that no particular heat input caused by an external factor affects the oil of the transmission oil circuit, for instance through a hydrodynamic converter, which optionally can be provided in the transmission oil circuit, can be driven by said oil of the transmission oil circuit acting as the working fluid, comparatively to the retarder or be cooled with said oil. It may hence prove necessary that the switchable heat exchanger is then only switched into the second position downstream of the work pressure valve respectively downstream of the switching valves/other transmission components/other units or the branch-off point, when the retarder as well as any other “particular heat source”, in particular the hydrodynamic converter, is switched off.

If a hydrodynamic retarder is provided, which is driven with said oil of the transmission oil circuit acting as the working fluid or is cooled by means of this oil, so that an additional heat exchanger, in this instance called retarder heat exchanger, be provided advantageously in the transmission oil circuit, through which the oil flows, in order to evacuate the heat from the working fluid of the retarder. If the oil of the transmission oil circuit is the working fluid of the retarder at the same time, the retarder heat exchanger comes into play, in order to evacuate the heat from the oil of the transmission oil circuit to the surrounding atmosphere, a cooling circuit or in any other appropriate manner. If the retarder is operated separately from the transmission oil circuit by means of its own working fluid circuit, a first heat exchanger (liquid-liquid-heat exchanger) can be provided, in order to transmit the heat from the working fluid circuit into the transmission oil circuit, as well as a second heat exchanger, advantageously connected downstream of the first heat exchanger transmission oil circuit, in order to evacuate the heat which is input in the first heat exchanger into the transmission oil circuit, to the surrounding atmosphere, a cooling circuit or in any other appropriate manner, from the oil of the transmission oil circuit. The second heat exchanger would be in such a case the so-called retarder heat exchanger.

If a retarder heat exchanger is provided the heat exchanger selectively switchable before or after the work pressure valve can advantageously be switched, as regards the sequence of circulation with the oil coming out of the oil pump, alternately parallel or in a row relative to the retarder heat exchanger, whereas the switching in a row relative to the retarder heat exchanger advantageously can be in such a way that the (switchable) heat exchanger is positioned in a row upstream of the retarder heat exchanger in the oil circuit.

According to an advantageously embodiment, the retarder heat exchanger can be switched alternately between a first position upstream of the work pressure valve or a second position downstream of the work pressure valve as regards the circulation sequence of the of the oil transmission oil circuit coming out of the oil pump. Also the first position in an alternative embodiment in the flow direction of the oil can here be situated upstream of the switching valves and/or the other transmission components and/or the other units outside the transmission respective when said elements are arranged in or downstream of a branching off supply line before the branch-off point, and the second position accordingly downstream of the branch-off point or downstream of the switching valves and/or other transmission components and/or other units. This arrangement will be described by way of example in the light of the different figures.

If a hydrodynamic converter is provided, which is supplied with the oil conveyed through the oil pump, that is to say the oil of the transmission oil circuit, or with another fluid in a separate circuit acting as a working fluid, so the hydrodynamic converter, when switched on, will always input heat into the oil of the transmission oil circuit. The switchable heat exchanger is hence advantageously always switched into the first position in the flow direction, when the hydrodynamic converter is switched on, and switched into the second position, when the hydrodynamic converter is switched off. In the latter case, please refer to the above as regards the optionally provided retarder. Switching the switchable heat exchanger in the flow direction of the oil comparatively further back into the second position should be avoided even when the hydrodynamic converter is switched off, if an additional intensive heat source is switched on in the transmission oil circuit, for instance a retarder.

To obtain the requested changeovers of the switchable heat exchanger and in particular, if available, of the switchable retarder heat exchanger, a single or a large number of control devices can be provided, which include the corresponding control logic, in order to switch the heat exchanger according to the described contingencies. The single control device or the large number of control devices can besides be used advantageously at the same time to switch the retarder and/or the hydrodynamic converter on and off. It goes without saying that additional control tasks can be undertaken by the control device. This operation takes place regardless whether the control logic is provided in a single control device or is distributed over several control devices.

The method according to the invention is characterised by the step of the conveying of oil from the oil sump by means of the oil pump, of the accumulation of the conveyed oil by means of the work pressure valve and of the cooling of the oil by means of the heat exchange, wherein in the first operating mode described, the heat exchanger is switched in the flow direction before the work pressure valve (first position) and in a second operating mode behind the work pressure valve (second position) as regards the flow of the oil in the transmission oil circuit, starting from the oil pump in the flow direction. The first operating mode can, as mentioned previously, be characterised by switching on a hydrodynamic retarder and/or a hydrodynamic converter, i.e. using a operating mode wherein a comparatively high heat is transferred into the transmission oil circuit. The second operating mode can be characterised in that the heat intensive units are switched off, that is to say in particular the hydrodynamic converter and the hydrodynamic retarder.

Also the first position in an alternative embodiment in the flow direction of the oil can here be situated upstream of the switching valves and/or the other transmission components and/or the other units outside the transmission respective when said elements are arranged in or downstream of a branching off supply line before the branch-off point, wherein then the second position is provided accordingly downstream of the branch-off point or the switching valves/transmission components/other units.

The invention will now be described below by way of example using an embodiment.

Wherein

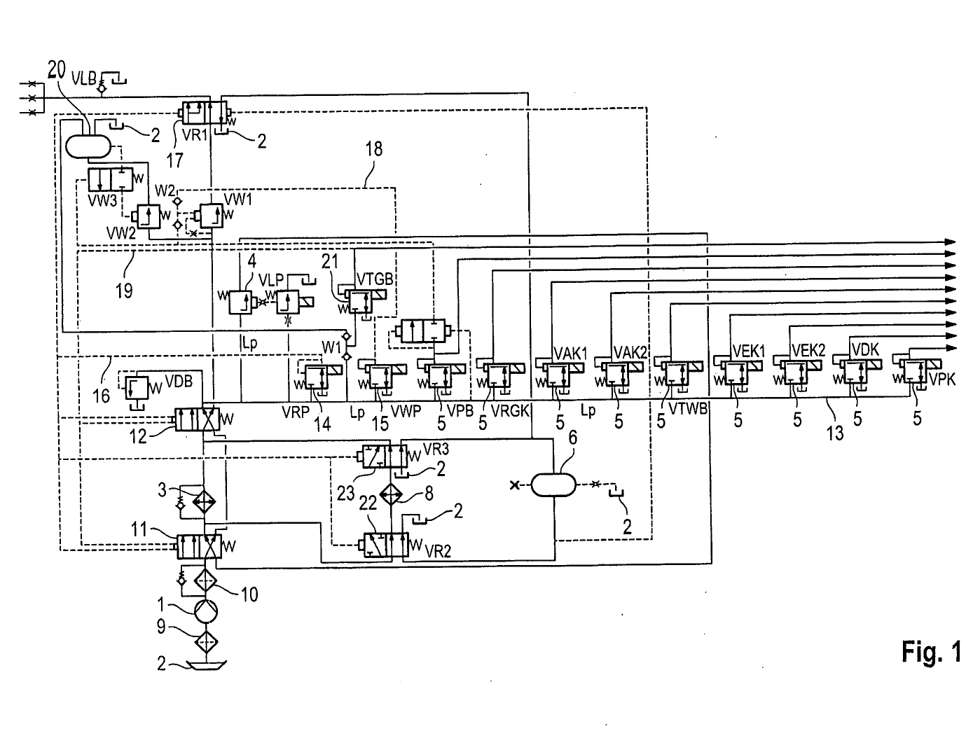

FIG. 1 shows a transmission oil circuit designed according to the invention;

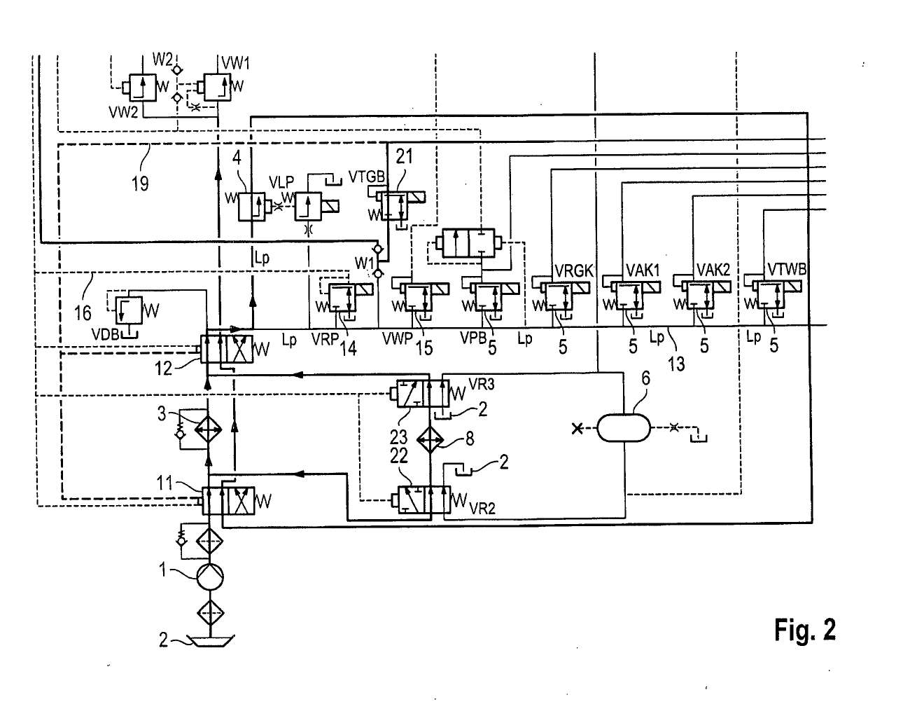

FIG. 2 shows the oil flow in the transmission oil circuit according to FIG. 1 in the first speed of the transmission when the retarder is switched off;

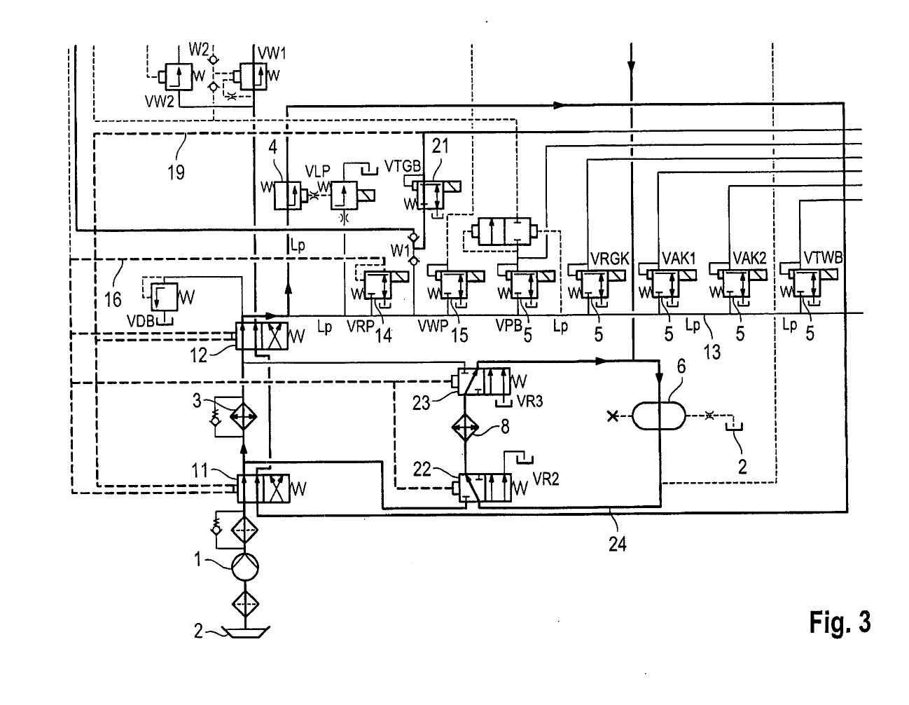

FIG. 3 shows the oil flow in the first speed of the transmission, however when the retarder is switched on;

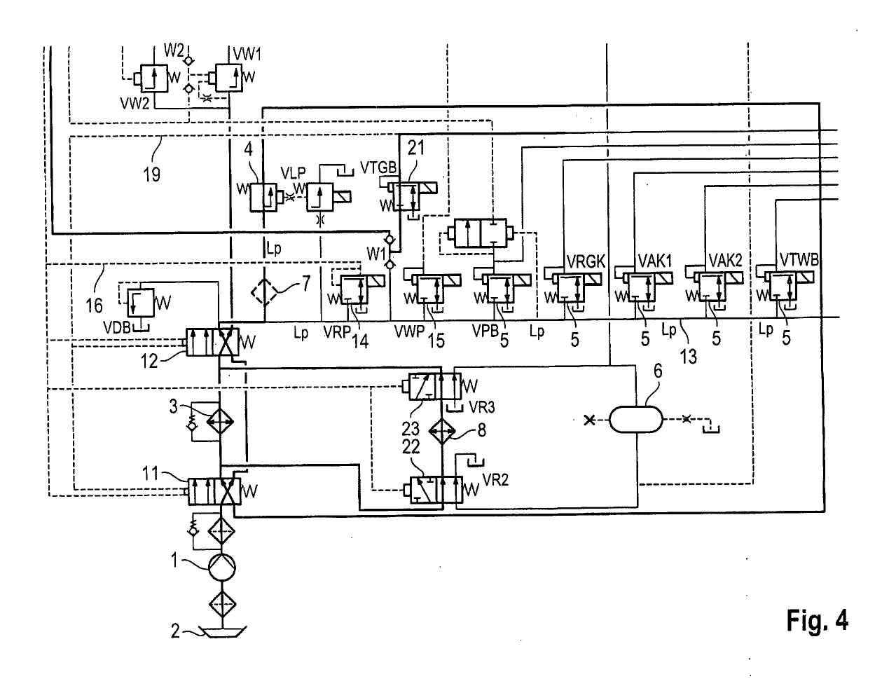

FIG. 4 shows the oil flow in the second speed and every higher speed when the retarder is switched off;

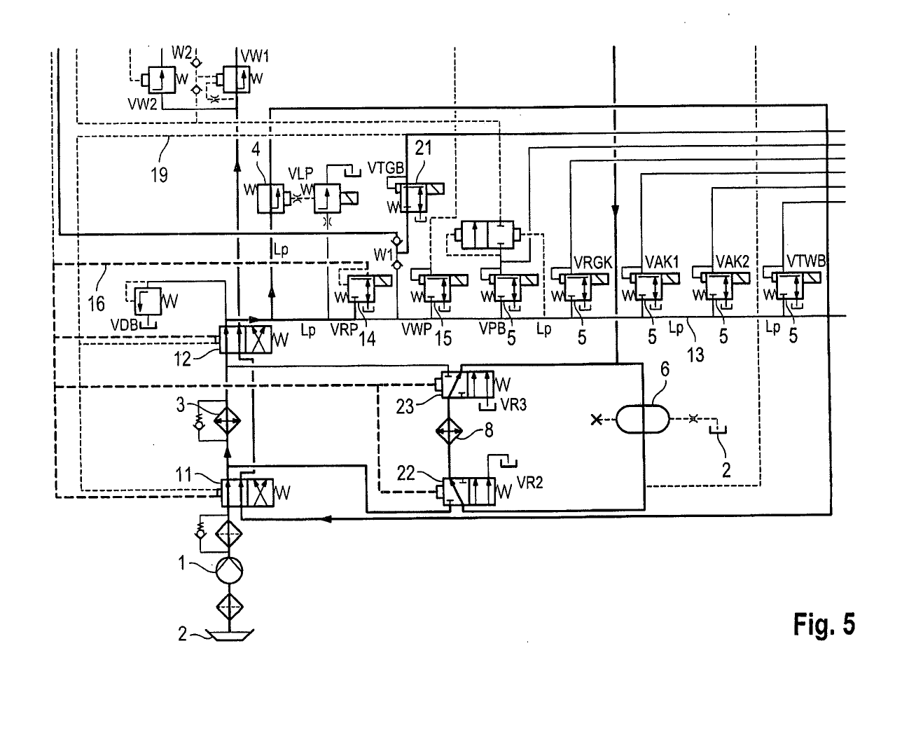

FIG. 5 shows the oil flow in the second speed and every higher speed when the retarder is switched on.

FIG. 1 represents a transmission oil circuit in a section, comprising an oil pump 1, which conveys the oil freely from an oil sump 2. In the illustrated embodiment, an oil sieve 9 is arranged in the flow direction of the oil upstream of the oil pump 1, which for instance can be arranged as a toothed gear, and a fine filter 10 in the flow direction downstream of the oil pump 1. These elements however only provide options and need not strictly be arranged.

Further down in the flow direction of the oil continues its course downstream of the oil pump 1, a heat exchanger 3 which represents the switchable heat exchanger according to the invention, is arranged in the oil circuit. In this instance, the heat exchanger 3 can be bypassed by means of a bypass fitted with a return valve, which conveys the oil past the heat exchanger 3 at a preset opening pressure, to prevent any excessive pressure loss. The opening pressure can for instance lie between 1 and 5 bars, in particular with a 2-bar differential pressure between the inlet of the heat exchanger 3 and the outlet of the heat exchanger 3. The heat exchanger 3 could also be designated as a sump heat exchanger.

A first switching valve 11 is connected upstream of the heat exchanger 3 in the flow direction of the oil and a second switching valve 12 is connected downstream thereof, whose purpose is to switch the heat exchanger 3 as regards its positioning in the oil circuit before or after the work pressure valve 4, as described below more in detail.

The work pressure valve 4 serves for accumulating a work pressure on the work pressure level 13, which is formed through a corresponding channel respectively a corresponding pipe, (also called work pressure rail or line), from which lines with switching valves 5 branch off and lead to different transmission components (non represented). The switching valves 5 determine whether a precise transmission component (or another unit outside the transmission) is loaded with the pressurised oil exiting from the work pressure level 13, wherein the corresponding switching valve 5 is opened more or less in the branching off line.

In the illustrated embodiment, a retarder pressure valve 14 as well as a converter pressure relief valve 15 are connected on the work pressure level 13. The retarder pressure valve 14 enables to adjust a preset control pressure in a control pressure line 16, which control pressure serves on the one hand for switching on and switching off the retarder 6 and on the other hand for adjusting a preset superimposed pressure in the retarder 6, when said retarder 6 is switched on, so as to adjust a preset braking torque of the retarder. For that purpose the control pressure line 16 includes a retarder switching valve 17, which in a first switching mode connects the retarder 6 to the oil sump 2 (or a separate oil sump) and in a second switching mode introduces oil from the transmission oil circuit, in particular the oil conveyed through the oil pump 1, into the work space of the retarder 6, whereas then, as described below more in detail, in the present embodiment a retarder oil circuit is formed inside the transmission oil circuit, wherein a retarder heat exchanger 8 is provided for evacuating the heat transferred into the oil by the retarder 6.

Moreover the control pressure line 16, wherein a control pressure is set according to the position of the retarder pressure valve 14 operates the first switching valve 11 upstream of the heat exchanger 3 and the second switching valve 12 downstream of the heat exchanger 3, so as to obtain the desired changeover of the heat exchanger 3 as regards its position in the transmission oil circuit, always when the retarder 6 is switched on and switched off.

According to the (first) control pressure line 16 for controlling respectively for switching on and switching off the retarder 6, a second control pressure line 18 is provided which is connected to the converter pressure relief valve 15 whereas the control pressure is determined in the second control pressure line 18 by the position of the converter pressure relief valve 15. The control pressure enables to relieve the pressure in the work space of the hydrodynamic converter 20 with accuracy, in order to reduce the drive power transmitted with the converter.

A third control pressure line 19 operates the first switching valve 11 upstream of the heat exchanger 3 and the second switching valve 12 downstream of the heat exchanger 3 always with the control pressure when the converter 20 is switched on. For that purpose, a corresponding control pressure valve 21 is provided, in this instance in a line branching off from the work pressure level 13.

The transmission components, which are controlled via the switching valves 5, are for instance couplings, brakes or claws, to select certain speeds (gears) in the transmission or to switch the converter 20 on or off.

A retarder heat exchanger 8 is provided for the retarder 6 in the present case operated with the oil from the transmission oil circuit acting as working fluid, whereas the position of said exchanger can also be changed over as regards the circulation with the oil in the transmission oil circuit. To do so a first retarder heat exchanger control valve 22 is provided in the flow direction of the oil upstream of the retarder heat exchanger 8 and a second retarder heat exchanger control valve 23 is provided downstream of the retarder heat exchanger 8, whereas both valves are operated parallel to the first switching valve 11 and to the second switching valve 12 upstream and downstream of the heat exchanger 3 with the control pressure coming from the first control pressure line 16.

Moreover, the retarder 6 can be connected, as represented, to the oil sump 2 (or a separate oil sump) via a line with comparatively small cross-section, or the oil leaking in the retarder 6 through poorly sealed points can be returned into the oil sump 2 (or the separate oil sump) in the oil circuit. In the illustrated embodiment, a connection of the retarder 6 or of the oil circuit formed for the retarder 6 can be provided via the first retarder heat exchanger control valve 22 and/or the second retarder heat exchanger control valve 23 with the oil sump 2 (or a separate oil sump), in order to empty the work space of the retarder, when the retarder 6 is switched off.

FIG. 2 now represents the oil flow in the transmission oil circuit when the first speed has been selected in the transmission and the retarder 6 is switched off, and using a sectional view of FIG. 1. Matching components are designated with matching reference signs.

In the first speed, the drive power is transmitted via the hydrodynamic converter 20 (non represented on FIG. 2) hydrodynamically from a drive machine (non represented), in particular a combustion engine, to the drive wheels (non represented) of the vehicle. Accordingly heat develops in the hydrodynamic converter 20, wherein said heat is absorbed by the oil of the transmission oil circuit and, inasmuch as the oil upstream of the work pressure level 13 is not cooled sufficiently, could cause overheating of electronic components in the switching valves 5. Accordingly the heat exchanger 3, and in the present embodiment parallel for that purpose, the retarder heat exchanger 8 are connected upstream of the work pressure valve 4 in the flow direction of the oil, starting from the oil sump 2 or the oil pump 1. In detail, the oil flows out of the oil pump 1 through the first switching valve 11, then parallel through the heat exchanger 3 and the retarder heat exchanger 8, again combined through the second switching valve 12, through the work pressure valve 4, then through a second line in the first switching valve 11, through a second line in the second switching valve 12 and towards the hydrodynamic converter (over the drawn bold line top left in FIG. 2). Consequently, the oil is cooled in the heat exchanger 3 as well as in the retarder heat exchanger 8, before it reaches the work pressure level 13, which branches off upstream of the work pressure valve 4, and hence the switching valves 5. In the switching mode illustrated on FIG. 2, the third control pressure line 19 is operated with control pressure, which implies that the first switching valve 11 and the second switching valve 12 remain in the illustrated positions. In this context, as the first control pressure line 16 is pressureless respective is operated with a control pressure lower than a limit value the first retarder heat exchanger control valve 22 and the second retarder heat exchanger control valve 23 are positioned in the specific illustrated position, wherein the retarder 6 is connected to the oil sump 2 (or a separate oil sump), to complement the oil sump connection over the retarder control valve 17 illustrated on FIG. 1, which also is not operated with a sufficient control pressure in the first control pressure line 16.

In the examples of embodiment illustrated here, the valves connected to the control pressure lines are designed as distributing valves or directional control valves, which are prestressed opposite to the corresponding control pressure, for instance by means of a pressure spring.

FIG. 3 now shows the operating mode wherein the retarder 6 is switched on additionally. In such a case, the first control pressure line 16 is additionally operated with control pressure, which still does not change anything to the switching position of the first switching valve 11 and of the second switching valve 12 (these valves are already operated with the control pressure of the third control pressure line 19 and consequently moved into the illustrated switching mode by opposing the force of the spring), which means that the heat exchanger 3 still remains switched before the work pressure valve 4 in the flow direction of the oil, however the first retarder heat exchanger control valve 22 and the second retarder heat exchanger control valve 23 are changed over in such a way that now the retarder heat exchanger 8 is switched in the flow direction of the oil together with the retarder 6 behind the work pressure valve 4, and in this instance in such a way that a retarder circuit 24 is formed inside the transmission oil circuit wherein in the retarder 6 heat is introduced into the oil, and in the retarder heat exchanger 8 said heat is evacuated from the oil.

The selected sequence of circulation of the various units in the transmission oil circuit creates the following situation: Since heat is input into the oil sump 2 through the hydrodynamic retarder 6 in particular through poorly sealed areas in the retarder 6, the oil conveyed through the oil pump 1 may present a comparatively high temperature, which is harmful to the switching valves 5 or to the electrical components contained into the switching valves 5. The heat exchanger 3 (sump heat exchanger) is hence switched in the flow direction of the oil before the work pressure valve 4 and consequently also upstream of the work pressure level 13. Another reason for connecting the heat exchanger 3 upstream of the work pressure valve 4 and hence the work pressure level 13 is the presence of the hydrodynamic converter switched on, which can also cause heat input into the oil sump 2, see the illustrated connection of the hydrodynamic converter 20 with the oil sump 2 according to FIG. 1. The heat exchanger 3 reduced the temperature of the oil conveyed through the oil pump 1 down to a temperature level, which is uncritical for the switching valves 5.

The operating mode illustrated in FIGS. 2 and 3 with the hydrodynamic converter switched on or with the hydrodynamic converter and hydrodynamic retarder switched on together is in this instance also designated as first operating mode.

FIG. 4 now represents the present mode designated as second operating mode, wherein the “heat sources”, hydrodynamic converter and hydrodynamic retarder are switched off. In this second operating mode, the oil pump 1 pumps the oil from the oil sump 2 first of all through the selected switching position of the first switching valve 11 and of the second switching valve 12 (neither the first control pressure line 16 nor the third control pressure line 19 include a control pressure, which switches the valves by opposing the force of the spring) on the heat exchanger past into the work pressure level 13 or through the work pressure valve 4. Consequently, the oil is still not cooled from the oil sump 2, before it enters the work pressure level 13 and the work pressure valve 4, which is however uncritical in the present case, since the heat input into the oil in the oil sump 2 is not larger. A considerable advantage is that a pressure loss over the heat exchanger 3, which can amount to 2 to 3 bars, can be saved in the flow direction upstream of the main pressure valve, which enables a 20-30% lower power consumption of the oil pump 1 and consequently, in case of use in a motor vehicle, reduces the drive power, in particular of the combustion engine which drives the oil pump 1, in a fuel-efficient manner.

In the flow direction downstream of the work pressure valve 4, the oil then flows through the again parallel switched heat exchanger 3 and retarder heat exchanger 8 and is cooled in both heat exchangers. The parallel connection of both heat exchangers triggers, as in the switching mode illustrated in FIG. 2, a pressure loss reduction due to the comparatively larger common flow cross-section available to the oil stream, wherein said section is formed through both heat exchangers. Consequently, the degree of efficiency can there again be increased or the loss can be reduced in the oil circuit. The illustrated position of the first retarder heat exchanger control valve 22 and of the second retarder heat exchanger control valve 23 is such that there is no control pressure or to be more accurate insufficient control pressure in the first control pressure line 16, which could switch the valves by opposing the force of the spring.

In the operating mode illustrated on FIG. 4, the switching positions of the first retarder heat exchanger control valve 22 and of the second retarder heat exchanger control valve 23 correspond to the switching positions of these valves according to FIG. 2, in order to obtain the desired parallel connection of both heat exchangers, whereas conversely the switching positions of the first switching valve 11 and of the second switching valve 12 have changed over with respect to the switching positions in FIGS. 2 and 3, in order to switch the heat exchanger 3 behind the work pressure valve 4.

If the transmission is operated only in the first speed with a hydrodynamic converter respectively with a power transmission by means of the hydrodynamic converter, so the operating mode according to FIG. 4 corresponds everyone of all higher speeds without using the hydrodynamic retarder, for instance the “mechanical” speeds 2 to 5. If several hydrodynamic speeds are provided for instance the hydrodynamic converter is switched on in the first speed and in the second speed for hydrodynamic driving (starting), the number of the purely mechanical speeds would increase accordingly, for instance to 3-5.

FIG. 5 now shows the operating mode wherein still the hydrodynamic converter or the power transmission over the hydrodynamic converter is switched off, however the retarder 6 is switched on. Consequently heat is input into the oil sump 2 and the first switching valve 11 as well as the second switching valve 12 are moved by a corresponding control pressure prevailing in the first control pressure pipe 16 into a specific switching position, wherein the heat exchanger is positioned in the flow direction of the oil upstream of the work pressure valve 4 and hence upstream of the work pressure level 13. The retarder 6 or the retarder heat exchanger 8 conversely is positioned due to a corresponding changeover of the first retarder heat exchanger control valve 22 and of the second retarder heat exchanger control valve 23 in the flow direction downstream of the work pressure valve 4. This changeover as well the switching on of the retarder 6 are triggered there again by the control pressure which is applied in the control pressure line 16, whereas conversely no control pressure is applied in the third control line 19, since the hydrodynamic converter is switched off.

In the specific switching states, wherein the retarder 6 is switched on (FIGS. 3 and 5) and consequently the heat exchanger 3 is positioned upstream of the work pressure valve 4 in the flow direction, the oil pump should consumers comparatively larger power since it should convey the oil from the oil sump 2 to a pressure level which lies above the pressure adjusted by the work pressure valve 4, that is to say is increased at least by the amount of pressure loss in the heat exchanger 3 as well as possibly of the additional units provided (oil sieve, fine filter, valves and similar). In these operating modes, an increased power consumption through the oil pump 1 is not detrimental, since this has the effect of braking the drive motor, usually the combustion engine, which is used for driving a vehicle which is desirable in the braking mode (the retarder 6 is indeed switched on).

The invention also enables then to save on the drive power in traction mode of the vehicle apart from during a hydrodynamic start (with said converter) and consequently even in a specific operating mode, which usually occurs most often when driving a vehicle. Instead of the hydrodynamic converter, a hydrodynamic coupling can also be used with the same advantages and effects of the provided changeover possibility of the heat exchanger 3 according to the invention.

Deviating from the embodiment described previously using the figures, the effect according to the invention can also be obtained inasmuch as that the switchable heat exchanger 3 in the operating mode, wherein comparatively little heat is transferred into the oil (second operating mode) is not switched downstream of the work pressure valve 4, but “only” behind the branch-off point upstream of the work pressure valve 4, at which the work pressure level 13 branches off. This position of the switchable heat exchanger is indicated in dotted lines on FIG. 4 and marked with the reference sign 7. If position 7 is selected as the second position of the switchable heat exchanger 3, whereas conversely the first position is arranged in the flow direction of the oil upstream of the branch-off point, there is hence no pressure loss in the second position caused by the switchable heat exchanger 3 upstream of the branch-off point, which should be overcome by the oil pump 1. Far more, said pressure loss only crops up downstream of the branch-off point, which is however insignificant since said loss can be compensated for by an accordingly less strong accumulation via the work pressure valve 4.

Even if in this instance it is not represented in detail, the transmission could basically also be operated with another fluid as oil, whereas the invention can be applied with the same efficiency. The concept of “oil circuit” should be hence understood its widest sense and should not only include the fluid “oil”, but also other equivalent fluids.

1-8. (canceled)

9. A transmission oil circuit comprising:
an oil pump for feeding oil or another fluid from an oil sump or corresponding fluid sump;
a heat exchanger, the oil flows through, for evacuating the heat from the oil;
a work pressure valve, against which the oil pump conveys the oil, so as to bring the conveyed oil to a preset work pressure for pressure actuation, applying hydraulic pressure or conveying hydraulic pressure to switching valves and/or other transmission components and/or other units outside the transmission, which are arranged in the flow direction upstream of the work pressure valve in a row with respect thereto, in a supply line or in the flow direction behind a supply line, which branches off in the transmission oil circuit upstream of the work pressure valve;
characterised in that:
the heat exchanger can be switched alternately in a first position upstream of the work pressure valve or in a second position downstream of the work pressure valve as regards the circulation sequence of the oil coming out of the oil pump, or
the heat exchanger can be switched, as regards the circulation sequence of the oil coming out of the oil pump, alternately in a first position upstream of the work pressure valve or in a second position downstream of the work pressure valve, and/or other transmission components and/or other units or when arranged in or downstream of the branched off supply line in a first position upstream of the branch-off point or a second position downstream of the branch-off position.

10. A transmission oil circuit according to claim 9, characterised in that a hydrodynamic retarder is provided, which is supplied with the oil conveyed through the oil pump or another fluid in a separate circuit as a working fluid, and at least one control device is provided, which is designed to switch the retarder on and off as well as to switch alternately the heat exchanger, and the at least one control device includes a control logic, which always switches the heat exchanger into the first position, when the retarder is switched on, and—possibly while taking into account additional heat input—then switches into the second position, when the retarder is switched off.

11. A transmission oil circuit according to claim 10, characterised in that a retarder heat exchanger the oil flows through is provided, in order to evacuate the heat from the working fluid of the retarder, and the heat exchanger can be switched as regards the sequence of circulation with the oil coming out of the oil pump alternately parallel or in a row relative to the retarder heat exchanger, the latter in particular in a row upstream of the retarder heat exchanger.

12. A transmission oil circuit according to claim 11, characterised in that also the retarder heat exchanger can be switched alternately in a first position upstream of the work pressure valve or in a second position downstream of the work pressure valve as regards the circulation sequence of the oil coming out of the oil pump, and/or alternately in a first position upstream of the switching valves or a second position downstream of the switching valves, and/or other transmission components and/or other units or when arranged in or downstream of the branched off supply line in a first position upstream of the branch-off point or a second position downstream of the branch-off position.

13. A transmission oil circuit according to claim 9, characterised in that a hydrodynamic converter is provided, which is supplied with the oil conveyed through the oil pump or another fluid in a separate circuit as a working fluid, at least one control device is provided, which is designed, in order to switch the hydrodynamic converter on and off as well as to switch alternately the heat exchanger and in particular the retarder heat exchanger, and the at least one control device includes a control logic, which directs oil through the heat exchanger and in particular the retarder heat exchanger the latter in particular parallel to the heat exchanger, then always switches into the first position, when the hydrodynamic converter is switched on and switches into the second position, when the hydrodynamic converter is switched off and in particular when the retarder is not switched on.

14. A transmission oil circuit according to claim 10, characterised in that a hydrodynamic converter is provided, which is supplied with the oil conveyed through the oil pump or another fluid in a separate circuit as a working fluid, at least one control device is provided, which is designed, in order to switch the hydrodynamic converter on and off as well as to switch alternately the heat exchanger and in particular the retarder heat exchanger, and the at least one control device includes a control logic, which directs oil through the heat exchanger and in particular the retarder heat exchanger the latter in particular parallel to the heat exchanger, then always switches into the first position, when the hydrodynamic converter is switched on and switches into the second position, when the hydrodynamic converter is switched off and in particular when the retarder is not switched on.

15. A transmission oil circuit according to claim 11, characterised in that a hydrodynamic converter is provided, which is supplied with the oil conveyed through the oil pump or another fluid in a separate circuit as a working fluid, at least one control device is provided, which is designed, in order to switch the hydrodynamic converter on and off as well as to switch alternately the heat exchanger and in particular the retarder heat exchanger, and the at least one control device includes a control logic, which directs oil through the heat exchanger and in particular the retarder heat exchanger the latter in particular parallel to the heat exchanger, then always switches into the first position, when the hydrodynamic converter is switched on and switches into the second position, when the hydrodynamic converter is switched off and in particular when the retarder is not switched on.

16. A transmission oil circuit according to claim 12, characterised in that a hydrodynamic converter is provided, which is supplied with the oil conveyed through the oil pump or another fluid in a separate circuit as a working fluid, at least one control device is provided, which is designed, in order to switch the hydrodynamic converter on and off as well as to switch alternately the heat exchanger and in particular the retarder heat exchanger, and the at least one control device includes a control logic, which directs oil through the heat exchanger and in particular the retarder heat exchanger the latter in particular parallel to the heat exchanger, then always switches into the first position, when the hydrodynamic converter is switched on and switches into the second position, when the hydrodynamic converter is switched off and in particular when the retarder is not switched on.

17. A method for controlling the oil flow in a transmission oil circuit according to claim 9, with the following steps:
conveying the oil from the oil sump by means of the oil pump;
accumulation of the conveyed oil by means of the work pressure valve, in order to bring the oil to a preset work pressure;
cooling the oil by means of the heat exchanger;
characterised in that:
the heat exchanger in a first operating mode is switched into a first position upstream of the work pressure valve and the oil fed through the oil pump is conveyed first through the heat exchanger and then through the work pressure valve, and in a second operating mode is switched into a second position downstream of the work pressure valve and the oil fed through the oil pump is conveyed first through the work pressure valve and then through the heat exchanger, or
the heat exchanger in a first operating mode is switched into a first position upstream of the switching valves, other transmission components and/or other units outside the transmission or in an arrangement inside or downstream of the branched off supply line and the oil fed through the oil pump is conveyed first through the heat exchanger and then through the switching valves, other transmission components and/or other units, and in a second operating mode is switched into a second position downstream of the switching valves, other transmission components and/or other and the oil fed through the oil pump is conveyed first through the switching valves, other transmission components and/or other units or the branch-off point and then through the heat exchanger.

18. A method for controlling the oil flow in a transmission oil circuit according to claim 10 with the following steps:
conveying the oil from the oil sump by means of the oil pump;
accumulation of the conveyed oil by means of the work pressure valve, in order to bring the oil to a preset work pressure;
cooling the oil by means of the heat exchanger;
characterised in that:
the heat exchanger in a first operating mode is switched into a first position upstream of the work pressure valve and the oil fed through the oil pump is conveyed first through the heat exchanger and then through the work pressure valve, and in a second operating mode is switched into a second position downstream of the work pressure valve and the oil fed through the oil pump is conveyed first through the work pressure valve and then through the heat exchanger, or
the heat exchanger in a first operating mode is switched into a first position upstream of the switching valves, other transmission components and/or other units outside the transmission or in an arrangement inside or downstream of the branched off supply line and the oil fed through the oil pump is conveyed first through the heat exchanger and then through the switching valves, other transmission components and/or other units, and in a second operating mode is switched into a second position downstream of the switching valves, other transmission components and/or other and the oil fed through the oil pump is conveyed first through the switching valves, other transmission components and/or other units or the branch-off point and then through the heat exchanger.

19. A method for controlling the oil flow in a transmission oil circuit according to claim 11, with the following steps:
conveying the oil from the oil sump by means of the oil pump;
accumulation of the conveyed oil by means of the work pressure valve, in order to bring the oil to a preset work pressure;
cooling the oil by means of the heat exchanger;
characterised in that:
the heat exchanger in a first operating mode is switched into a first position upstream of the work pressure valve and the oil fed through the oil pump is conveyed first through the heat exchanger and then through the work pressure valve, and in a second operating mode is switched into a second position downstream of the work pressure valve and the oil fed through the oil pump is conveyed first through the work pressure valve and then through the heat exchanger, or
the heat exchanger in a first operating mode is switched into a first position upstream of the switching valves, other transmission components and/or other units outside the transmission or in an arrangement inside or downstream of the branched off supply line and the oil fed through the oil pump is conveyed first through the heat exchanger and then through the switching valves, other transmission components and/or other units, and in a second operating mode is switched into a second position downstream of the switching valves, other transmission components and/or other and the oil fed through the oil pump is conveyed first through the switching valves, other transmission components and/or other units or the branch-off point and then through the heat exchanger.

20. A method for controlling the oil flow in a transmission oil circuit according to claim 12, with the following steps:
conveying the oil from the oil sump by means of the oil pump;
accumulation of the conveyed oil by means of the work pressure valve, in order to bring the oil to a preset work pressure;
cooling the oil by means of the heat exchanger;
characterised in that:
the heat exchanger in a first operating mode is switched into a first position upstream of the work pressure valve and the oil fed through the oil pump is conveyed first through the heat exchanger and then through the work pressure valve, and in a second operating mode is switched into a second position downstream of the work pressure valve and the oil fed through the oil pump is conveyed first through the work pressure valve and then through the heat exchanger, or
the heat exchanger in a first operating mode is switched into a first position upstream of the switching valves, other transmission components and/or other units outside the transmission or in an arrangement inside or downstream of the branched off supply line and the oil fed through the oil pump is conveyed first through the heat exchanger and then through the switching valves, other transmission components and/or other units, and in a second operating mode is switched into a second position downstream of the switching valves, other transmission components and/or other and the oil fed through the oil pump is conveyed first through the switching valves, other transmission components and/or other units or the branch-off point and then through the heat exchanger.

21. A method for controlling the oil flow in a transmission oil circuit according to claim 13, with the following steps:
conveying the oil from the oil sump by means of the oil pump;
accumulation of the conveyed oil by means of the work pressure valve, in order to bring the oil to a preset work pressure;
cooling the oil by means of the heat exchanger;
characterised in that:
the heat exchanger in a first operating mode is switched into a first position upstream of the work pressure valve and the oil fed through the oil pump is conveyed first through the heat exchanger and then through the work pressure valve, and in a second operating mode is switched into a second position downstream of the work pressure valve and the oil fed through the oil pump is conveyed first through the work pressure valve and then through the heat exchanger, or
the heat exchanger in a first operating mode is switched into a first position upstream of the switching valves, other transmission components and/or other units outside the transmission or in an arrangement inside or downstream of the branched off supply line and the oil fed through the oil pump is conveyed first through the heat exchanger and then through the switching valves, other transmission components and/or other units, and in a second operating mode is switched into a second position downstream of the switching valves, other transmission components and/or other and the oil fed through the oil pump is conveyed first through the switching valves, other transmission components and/or other units or the branch-off point and then through the heat exchanger.

22. A method for controlling the oil flow in a transmission oil circuit according to claim 14, with the following steps:
conveying the oil from the oil sump by means of the oil pump;
accumulation of the conveyed oil by means of the work pressure valve, in order to bring the oil to a preset work pressure;
cooling the oil by means of the heat exchanger;
characterised in that:
the heat exchanger in a first operating mode is switched into a first position upstream of the work pressure valve and the oil fed through the oil pump is conveyed first through the heat exchanger and then through the work pressure valve, and in a second operating mode is switched into a second position downstream of the work pressure valve and the oil fed through the oil pump is conveyed first through the work pressure valve and then through the heat exchanger, or
the heat exchanger in a first operating mode is switched into a first position upstream of the switching valves, other transmission components and/or other units outside the transmission or in an arrangement inside or downstream of the branched off supply line and the oil fed through the oil pump is conveyed first through the heat exchanger and then through the switching valves, other transmission components and/or other units, and in a second operating mode is switched into a second position downstream of the switching valves, other transmission components and/or other and the oil fed through the oil pump is conveyed first through the switching valves, other transmission components and/or other units or the branch-off point and then through the heat exchanger.

23. A method for controlling the oil flow in a transmission oil circuit according to claim 15, with the following steps:
conveying the oil from the oil sump by means of the oil pump;
accumulation of the conveyed oil by means of the work pressure valve, in order to bring the oil to a preset work pressure;
cooling the oil by means of the heat exchanger;
characterised in that:
the heat exchanger in a first operating mode is switched into a first position upstream of the work pressure valve and the oil fed through the oil pump is conveyed first through the heat exchanger and then through the work pressure valve, and in a second operating mode is switched into a second position downstream of the work pressure valve and the oil fed through the oil pump is conveyed first through the work pressure valve and then through the heat exchanger, or
the heat exchanger in a first operating mode is switched into a first position upstream of the switching valves, other transmission components and/or other units outside the transmission or in an arrangement inside or downstream of the branched off supply line and the oil fed through the oil pump is conveyed first through the heat exchanger and then through the switching valves, other transmission components and/or other units, and in a second operating mode is switched into a second position downstream of the switching valves, other transmission components and/or other and the oil fed through the oil pump is conveyed first through the switching valves, other transmission components and/or other units or the branch-off point and then through the heat exchanger.

24. A method for controlling the oil flow in a transmission oil circuit according to claim 16, with the following steps:
conveying the oil from the oil sump by means of the oil pump;
accumulation of the conveyed oil by means of the work pressure valve, in order to bring the oil to a preset work pressure;
cooling the oil by means of the heat exchanger;
characterised in that:
the heat exchanger in a first operating mode is switched into a first position upstream of the work pressure valve and the oil fed through the oil pump is conveyed first through the heat exchanger and then through the work pressure valve, and in a second operating mode is switched into a second position downstream of the work pressure valve and the oil fed through the oil pump is conveyed first through the work pressure valve and then through the heat exchanger, or
the heat exchanger in a first operating mode is switched into a first position upstream of the switching valves, other transmission components and/or other units outside the transmission or in an arrangement inside or downstream of the branched off supply line and the oil fed through the oil pump is conveyed first through the heat exchanger and then through the switching valves, other transmission components and/or other units, and in a second operating mode is switched into a second position downstream of the switching valves, other transmission components and/or other and the oil fed through the oil pump is conveyed first through the switching valves, other transmission components and/or other units or the branch-off point and then through the heat exchanger.

25. A method according to claim 17, characterised in that the first operating mode is set by switching on a hydrodynamic retarder and/or a hydrodynamic converter, which is driven by the oil acting as a working fluid or whose working fluid is cooled by the oil, and the second operating mode is set by switching off the hydrodynamic converter and, if provided, by switching off the hydrodynamic retarder.

26. A method according to claim 18, characterised in that the first operating mode is set by switching on a hydrodynamic retarder and/or a hydrodynamic converter, which is driven by the oil acting as a working fluid or whose working fluid is cooled by the oil, and the second operating mode is set by switching off the hydrodynamic converter and, if provided, by switching off the hydrodynamic retarder.

27. A method according to claim 19, characterised in that the first operating mode is set by switching on a hydrodynamic retarder and/or a hydrodynamic converter, which is driven by the oil acting as a working fluid or whose working fluid is cooled by the oil, and the second operating mode is set by switching off the hydrodynamic converter and, if provided, by switching off the hydrodynamic retarder.

28. A method according to claim 25, characterised in that systematically when the hydrodynamic converter is switched on and the hydrodynamic retarder is switched off, the oil is conveyed out of the oil pump in parallel through the heat exchanger and the retarder heat exchanger for evacuating the heat from the oil in both heat exchangers and then combined through the work pressure valve.
